(19) United States
(12) Patent Application Publication
(10) Pub. No.: US 2024/0002160 A1
(43) Pub. Date: Jan. 4, 2024

(54) PROCESS FOR CONTROLLING A CONVEYOR LINE FOR ITEMS OF GENERAL CARGO THAT HAS BEEN ADDED BY RETROFITTING

(71) Applicant: Siemens Aktiengesellschaft, München (DE)

(72) Inventors: Michel Tokic, Tettnang (DE); Anja von Beuningen, Erfurt (DE); Martin Bischoff, Aying (DE); David Grossenbacher, Prag 6-Dejvice (CZ)

(21) Appl. No.: 18/215,237

(22) Filed: Jun. 28, 2023

(30) Foreign Application Priority Data
Jun. 30, 2022 (EP) 22182426.1

(51) Int. Cl. B65G 43/08; B65G 47/68; G05B 13/02

(52) U.S. Cl. CPC B65G 43/08; B65G 47/681; G05B 13/0265; B65G 2203/0233; B65G 2811/095

(57) ABSTRACT

A process for controlling a conveyor line for general cargo is provided, the conveyor line including a plurality of consecutive conveyor line portions, each of which is driven by a drive. The drives are controlled by a computing unit using a machine learning model. The machine learning model accomplishes this by getting first input data on the basis of current operating information from at least one further conveyor line that it does not control. The machine learning model has previously been trained using second input data on the basis of operating information of the at least one further conveyor line. The operating information of the at least one further conveyor line in this instance relates to measured values from sensors for detecting general cargo and speeds of conveyor line portions.

### CROSS-REFERENCE TO RELATED APPLICATIONS

This application claims priority to EP Application No. 22182426.1, having a filing date of Jun. 30, 2022, the entire contents of which are hereby incorporated by reference.

### FIELD OF TECHNOLOGY

The following relates to a process for controlling a conveyor line for general cargo, the controlled conveyor line comprising a plurality of consecutive conveyor line portions, each of which is driven by a drive.

### BACKGROUND

Many logistical systems are based on conveyor lines being used to transport items of general cargo such as e.g., packages or individual products. A conveyor line in this instance is usually made up of a plurality of conveyor line portions, which are arranged in succession, with the result that an item of general cargo can be transferred from one conveyor line portion to another, adjoining conveyor line portion without interruption. Each conveyor line portion contains a conveyor belt on which the item of general cargo is moved. Alternatives to conveyor belts are rail systems or multicarrier systems. Multiple such conveyor lines can in turn be combined in an arbitrarily complicated manner, e.g., by virtue of multiple conveyor lines running parallel to one another and opening into a common section.

Each of the conveyor belts of the conveyor line portions is operated using a dedicated drive, with the result that the speed of each conveyor line portion is individually adjustable. This actuation is usually performed using a fast clocking, with the result that the time at which an item of general cargo arrives at a specified destination in particular on the last conveyor line portion can be set very accurately. This requires the conveyor line portions to be accelerated or decelerated in an optimum manner by their respective associated drive on the basis of control signals from a computing unit. Poor control is manifested e.g., by items of general cargo colliding, falling from the conveyor line, not reaching the desired destination or, at the destination, not maintaining a desired minimum distance from the item of general cargo that has previously arrived there.

### SUMMARY

An aspect relates to demonstrating a process for controlling a conveyor line for general cargo.

The process according to embodiments of the invention is used for controlling a conveyor line for general cargo. The conveyor line in this instance comprises a plurality of consecutive conveyor line portions, each of which is driven by a drive. The drives are controlled by a computing unit using a machine learning model. For this purpose, that is to say to control the conveyor line, the machine learning model gets first input data on the basis of current operating information from at least one further conveyor line that it does not control. The machine learning model has previously been trained using second input data on the basis of operating information of the at least one further conveyor line. The operating information of the at least one further conveyor line relates to measured values from sensors for detecting general cargo and speeds of conveyor line portions.

A conveyor line having multiple conveyor line portions that needs to be controlled by the machine learning model is available. As a result of each of the conveyor line portions having a dedicated drive, they can be individually accelerated or decelerated. This acceleration or deceleration can also comprise an acceleration or deceleration value of 0, i.e., a conveyor line portion can also be operated at least intermittently at constant speed. The selective acceleration or deceleration of each conveyor line portion allows an aim prescribed for the conveyor line to be achieved, e.g., a transported item of general cargo being at the end of the last conveyor line portion at a specified time. The drives of the conveyor line portions are controlled by a computing unit. The latter tells the drives what speed needs to be set or alternatively what acceleration or deceleration.

Apart from the conveyor line that needs to be controlled by the machine learning model, there is or are one or more further conveyor lines, the operation of which influences the control of the conveyor line. The operating information of the conveyor line(s) is used, directly or in processed form, both for training the machine learning model and for controlling the conveyor line by way of the machine learning model. The input data provided to the machine learning model for control purposes are current information, i.e., they describe the current state of the at least one conveyor line that the machine learning model does not control. Of course, this does not prevent a certain time delay that may exist between the ascertainment of the state of the at least one further conveyor line and the reception of the input data by the machine learning model. By contrast, the input data that are used by the machine learning model for training may be historical information; i.e., the respective operating information may have been gathered at an earlier time.

The operating information of the at least one further conveyor line relates to measured values from sensors for detecting general cargo and speeds of conveyor line portions. The at least one further conveyor line comprises a plurality of conveyor line portions, at least one of the conveyor line portions being equipped with a sensor for detecting general cargo. It is possible that some or all of the conveyor line portions have such a sensor, and also that there is provision for multiple sensors per conveyor line portion. The positioning of the sensors in relation to the extent of the conveyor line portions may be the same, e.g., always at the start of a conveyor line portion, but it may also differ from conveyor line portion to conveyor line portion. The sensors are light barriers. Other examples of suitable sensors are: 2D/3D cameras, RFID receivers in combination with RFID tags on the general cargo, induction loops.

Besides the conveyor line that needs to be controlled by the machine learning model, there may be one or more additional conveyor lines that are also controlled by the machine learning model. With regard to these, the process described can be applied accordingly.

In one development of embodiments of the invention, the first and second input data comprise at least one temporal forecast value concerning the arrival of an item of general cargo conveyed on the at least one further conveyor line at a specified position, which forecast value is determined from the operating information. This at least one forecast value can be ascertained by the machine learning model; in this case, the machine learning model initially gets the operating information, from which it ascertains the input data in the form of the at least one forecast value. Alternatively, the at least one forecast value can also be ascertained outside the machine learning model, with the result that the machine learning model gets only the at least one forecast value, and not the operating information in addition, as input data.

The at least one forecast value imparts time-related information. This is the period of time yet to elapse before the next item of general cargo reaches the specified position. Additionally or alternatively, a forecast value can also be used for a period of time whose expiry means that this item of general cargo will have left the specified position again. It is also possible to forecast multiple periods of time before the second-closest, third-closest, etc. item of general cargo reaches and/or leaves the specified position.

The forecast relates in each case to items of general cargo that are not transported on the conveyor line controlled by the machine learning model, i.e., arrival at the specified position is not subject to the control of the machine learning model.

The specified position is a position surveyed by a sensor in order to detect general cargo. It may be located on the at least one further conveyor line, at the end thereof. The specified position may also be arranged outside the at least one further conveyor line, however, e.g., on a device that follows the at least one further conveyor line. It is particularly advantageous if the specified position is located on a section that is common to the conveyor line controlled by the machine learning model and to the at least one further conveyor line.

In one development of embodiments of the invention, the at least one forecast value is ascertained by forming at least one sawtooth function that indicates a remaining period of time before an item of general cargo conveyed on the at least one further conveyor line arrives at the specified position. The use of a sawtooth function permits the at least one forecast value to be predicted over many time steps. It is particularly advantageous in this case if the at least one sawtooth function is formed from measured values from a sensor that surveys the specified position in order to detect general cargo.

According to one configuration of embodiments of the invention, the at least one forecast value is ascertained by a forecast model that is independent of the machine learning model, the forecast model having been produced using operating information of the at least one further conveyor line. Two models are thus used: the machine learning model to control the conveyor line and the forecast model to produce the forecast values. The latter was produced using operating information of the at least one further conveyor line, with the result that such operating information is required as input in order to ascertain forecast values. The results of the forecast model, that is to say the forecast values, are then provided to the machine learning model by the forecast model.

In one development of embodiments of the invention, the conveyor line and the at least one further conveyor line convey items of general cargo to a common section. The conveyor line controlled by the machine learning model and the at least one further conveyor line therefore form a system in which items of general cargo on different conveyor lines are transported to a section that is common to these different conveyor lines, which section can follow the end of the respective conveyor lines.

In one configuration of embodiments of the invention, the machine learning model has been trained using a reinforcement learning algorithm with the stipulation that items of general cargo need to be conveyed on the controlled conveyor line in such a way that they reach the common section at a prescribed distance from items of general cargo on the at least one further conveyor line. This prescribed distance may be e.g., zero, i.e., two items of general cargo on different conveyor lines are meant to be directly consecutive, e.g., with the aim of packaging multiple items of general cargo in parallel, or may be a specified minimum distance, or an exact indication of distance.

It is particularly advantageous if the specified position is located on the common section. This allows the forecast values to be taken as a basis for identifying when the specified position on the common section is not occupied by items of general cargo on the at least one further conveyor line, which means that it can be occupied by items of general cargo that are conveyed on the conveyor line controlled by the machine learning model.

In one configuration of embodiments of the invention, the machine learning model, for the purpose of control, gets third input data on the basis of current operating information of the conveyor line that it controls, and it has been trained using fourth input data on the basis of operating information of the conveyor line that it controls, which operating information is gotten from a simulation. The type of operating information in this instance corresponds to the operating information of the at least one further conveyor line, i.e., it relates to measured values from sensors for detecting general cargo and speeds of conveyor line portions.

According to one development of embodiments of the invention, the at least one further conveyor line is controlled using a control algorithm that is unknown to the machine learning model. Although the control of the conveyor line by the machine learning model is therefore based on the operating information of the at least one conveyor line that it does not control, it is not based on knowledge about the process for controlling this at least one further conveyor line.

The process according to embodiments of the invention and/or one or more functions, features and/or steps of the process according to embodiments of the invention and/or of one of its configurations can proceed in a computer-aided manner. The process can be carried out and implemented, respectively, for example by one or more computers, processors, application-specific integrated circuits (ASICs), digital signal processors (DSPs) and/or what are known as “field-programmable gate arrays” (FPGAs). It can also be carried out at least in part in a cloud and/or in an edge computing environment. One or more interacting computer programs are used to allow it to proceed in a computer-aided manner. If multiple programs are used, these can be jointly stored on a computer and executed by the computer, or on different computers at different locations. Since this is synonymous in terms of function, “the computer program” and “the computer” are worded in the singular in the present case.

### BRIEF DESCRIPTION

Some of the embodiments will be described in detail, with reference to the following figures, wherein like designations denote like members, wherein:

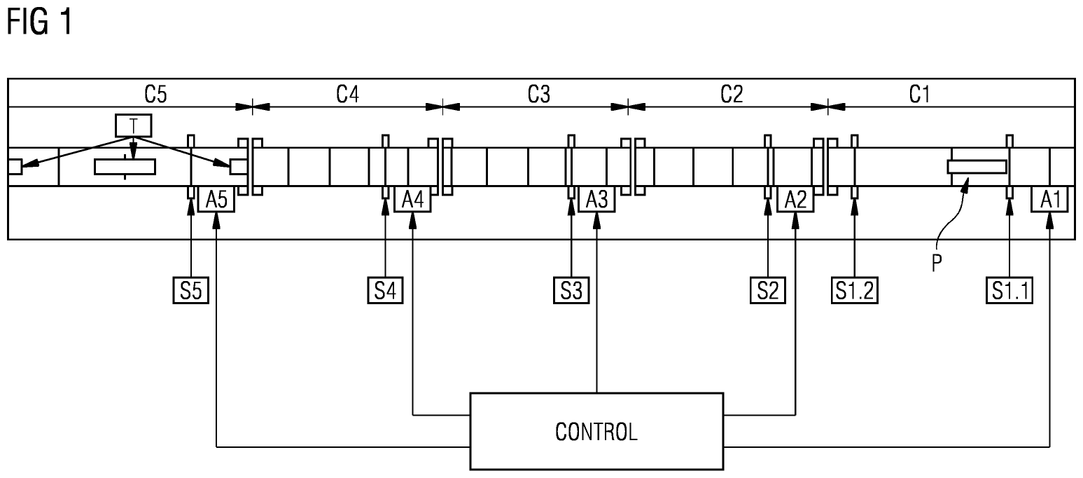

FIG. 1 shows a simple conveyor line;

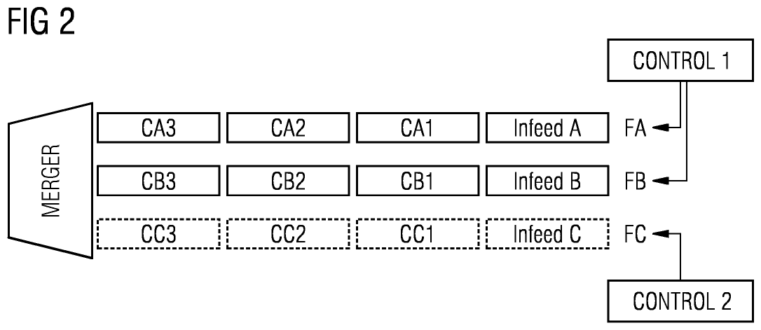

FIG. 2 shows a conveyor line having multiple fingers;

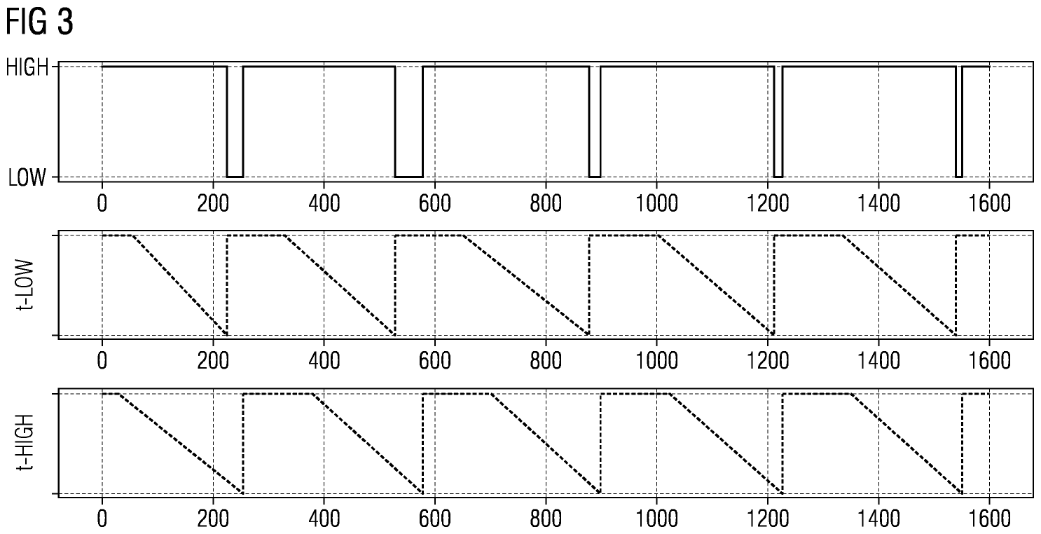

FIG. 3 shows a response for operating data of a conveyor line and information derived therefrom;

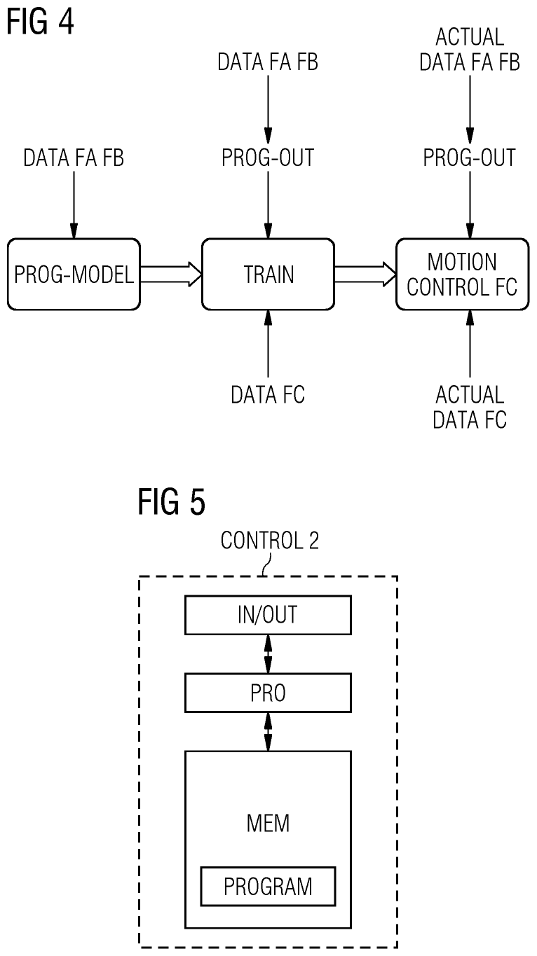

FIG. 4 shows a flowchart;

FIG. 5 shows a control unit for controlling the movement of a conveyor line; and

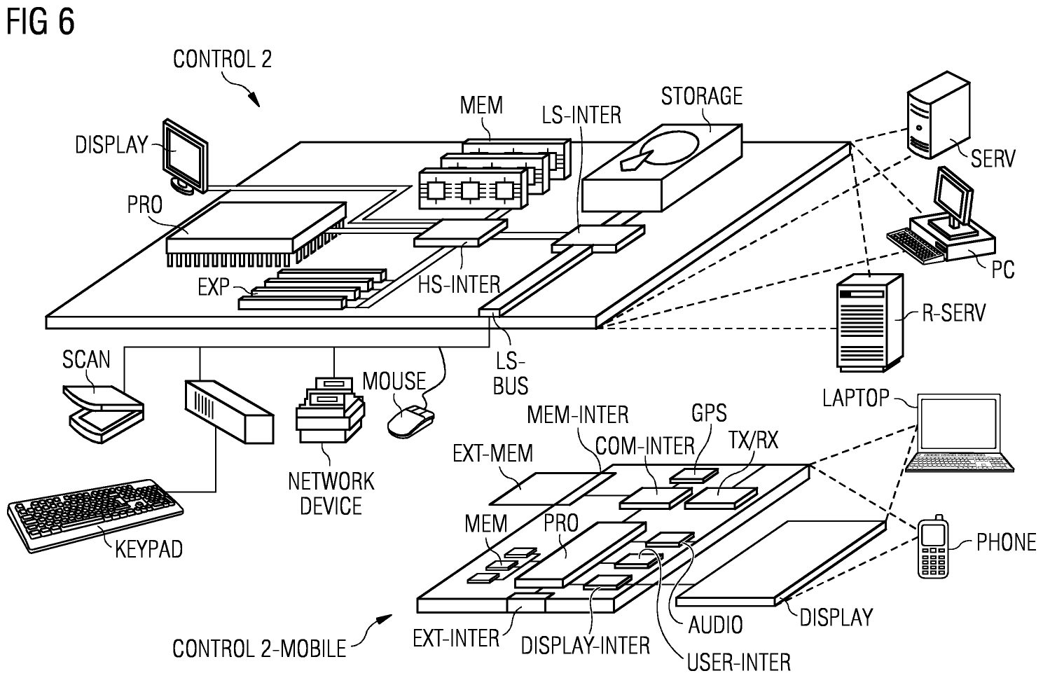

FIG. 6 shows a more detailed representation of the control unit.

### DETAILED DESCRIPTION

Conveyor lines having multiple individually actuatable conveyor belt sections are often used in intralogistics or in the production setting in general. FIG. 1 shows such a conveyor line, which can be used e.g., for a packaging machine. Here, products on the conveyor line need to be accelerated/decelerated in order to deliver the product to suit the clock frequency of a flow-wrapping machine, not shown, at the end of the conveyor line. In the illustration, the product P coming from the right is transported to the left by the conveyor line portions in the form of the conveyor belts C1, C2, C3, C4, C5. The product P is an inherently arbitrary item of general cargo. The conveyor belts C1, C2, C3, C4, C5 may be of identical length or may have different lengths.

Each of the conveyor belts C1, C2, C3, C4, C5 has a respective associated drive A1, A2, A3, A4, A5. The conveyor belts C1, C2, C3, C4, C5 can be individually accelerated or decelerated by appropriately actuating the drives A1, A2, A3, A4, A5 by a control unit CONTROL, illustrated by the arrows, symbolizing the actuation signals, from the control unit CONTROL to the respective drive A1, A2, A3, A4, A5. The aim of this individual control of the movement of the conveyor belts C1, C2, C3, C4, C5 is to place the product at a specified destination T on the last conveyor belt C5. The items of general cargo are supplied to the conveyor line by way of the conveyor belt C1, which serves as a transfer unit and which, as shown, is also in the form of a conveyor line portion. In general, therefore, general cargo that enters at random, both in regard to times and in regard to size, is available, which needs to be put down at prescribed positions.

In order to render the control unit CONTROL able to generate suitable actuation signals for accelerating and decelerating the drives A1, A2, A3, A4, A5, the conveyor belts C1, C2, C3, C4, C5 are provided with sensors. In the example in FIG. 1, the sensors S1.1, S1.2, S2, S3, S4, S5 are distributed as follows: the first conveyor belt C1 has two sensors, the sensor S1.1 at the start and the sensor S1.2 at the end, all of the other conveyor belts each having a sensor S2, S3, S4 and S5. The sensors may e.g., not be positioned directly at the start/end of the individual conveyor belts, but rather may be at a short distance from the start of the conveyor belt; in general, however, they may be disposed at any positions. It is also not necessary for every conveyor belt to be provided with one or more sensors. The sensors S1.1, S1.2, S2, S3, S4, S5 are light barriers. These output the binary values LOW and HIGH, LOW meaning that there is a product in the light barrier. Furthermore, there may be provision for further sensors for ascertaining the speeds of the conveyor belts C1, C2, C3, C4, C5, such as e.g., speed sensors for detecting the speed of the drives A1, A2, A3, A4, A5, current sensors for detecting motor currents of the drives A1, A2, A3, A4, A5, etc. Alternatively, the speeds of the conveyor belts C1, C2, C3, C4, C5 can be assumed to be known from the actuation signals of the control unit CONTROL.

The conveyor line shown in FIG. 1 is a simple example. More complex conveyor lines comprise multiple fingers, which in turn contain multiple conveyor belts connected in series. Each finger of a more complex conveyor line of this kind is thus designed as shown in FIG. 1, in principle. Conveyor lines having multiple fingers are used e.g., in package sorting installations to singularize packages of different or identical sizes. Another example is a packaging machine in which the products to be packaged on a conveyor line need to be accelerated/decelerated in order to deliver the product to suit the clock frequency of the flow-wrapping machine at the end of the conveyor line. A specific example of a more complex conveyor line is what is known as a “dynamic gapper”, an automatically controlled drive application recently used in intralogistics.

FIG. 2 shows a conveyor line having multiple fingers. By way of illustration, it comprises three conveyor lines FA, FB, FC running parallel to one another, on each of which it is possible to convey products, such as e.g., packages, in a conveying direction that runs from right to left. Each of the conveyor lines FA, FB, FC comprises a plurality of conveyor belts Infeed A, CA1, CA2, CA3, Infeed B, CB1, CB2, CB3, Infeed C, CC1, CC2, CC3. The number of conveyor belts per conveyor line FA, FB, FC is identical in the present exemplary embodiment, but this is not imperative. The conveyor belts of each conveyor line FA, FB, FC may be of identical length or may have different lengths. For the sake of clarity, sensors and drives are not shown.

A product reaches the conveyor line FA, FB, FC on the first conveyor belt in each case Infeed A, Infeed B, Infeed C. Arranged at the end of the conveyor lines FA, FB, FC is the combining unit MERGER, to which the last conveyor belts CA3, CB3, CC3 in the conveying direction transfer the products that they transport. At an output of the combining unit, there is a single output conveyor line. The product flow is combined on this outgoing conveyor belt.

The individual acceleration and deceleration of the conveyor belts of the fingers allows products transported on the various fingers to be transported to the combining unit MERGER as required, e.g., at staggered times. The combining unit MERGER is therefore rendered able to convey a product to the output conveyor line in such a way that two temporally successive products are at a prescribed defined minimum distance from one another. Alternatively, it is also possible for two or more products on different conveyor lines FA, FB, FC to be intended to be transported to the output conveyor line at the same time, e.g., because they need to be packaged together.

The text below considers the situation in which a further supply arm in the form of the conveyor line FC is added to an existing installation in the form of the conveyor lines FA and FB. The conveyor lines FA and FB are already controlled by the control unit CONTROL 1. The present problem is thus that of expanding running conveyor lines, known as retrofitting.

The aim of the expansion may be to increase product throughput. To achieve this, the intention is to cleverly exploit product gaps on the combining unit MERGER by way of the installation expansion by transferring the products on the new conveyor line FC to the combining unit MERGER precisely when a gap opens up. This improves product throughput. Another objective may be for products on the new conveyor line FC to be packaged together with a product on an existing conveyor line FA and/or FB, that is to say to be intended to arrive on the combining unit MERGER at the same time as the latter product.

The optimum speeds of the individual conveyor belts of the finger FC are determined by the control unit CONTROL 2. Achieving the aforementioned aims, e.g., increasing product throughput, requires planning action that extends into the future, which requires estimation of the number, sizes and positions of the gaps. The control unit CONTROL 2 is intended to determine optimum speeds for the conveyor belts of the conveyor line FC at any time and in any desired situation as far as the number, sizes and positions of the individual products on the conveyor lines FA, FB, FC are concerned. What is important is that the control unit CONTROL 2 has no physical model, e.g., in the form of a simulation, of the installation that is to be expanded available for this. The reason for the lack of detailed knowledge regarding the circumstances of the installation that is to be expanded may be e.g., that this is an operational secret of the installation designer of the installation that is to be expanded. The absence of knowledge regarding the existing installation allows an installation of a first manufacturer, which is controlled by a first control unit CONTROL 1, to be expanded by a finger of another manufacturer, which is then controlled by a second control unit CONTROL 2, in order to improve productivity.

The second control unit CONTROL 2 does not know the control algorithm of the first control unit CONTROL 1. The only prerequisite is that the first control unit CONTROL 1 takes deterministic precedence over the existing installation. That is to say that under identical circumstances the speeds for the conveyor lines FA, FB are determined in the same way, without random aspects. The second control unit CONTROL 2 does not require access to the first control unit CONTROL 1 of the original installation, nor any expert knowledge about control of the original installation. Expansion of an existing installation by a further conveyor belt using the approach described is therefore possible not only for the original constructor of the conveyor belt.

One prerequisite is that operating data about the behavior of the existing installation are provided. These are the light barrier signals and the conveyor belt speeds of the conveyor lines FA and FB. The conveyor belt speeds are the speeds that actually exist. These may be slightly staggered over time compared with the set speeds of the first control unit CONTROL 1. Additionally, the operating data available may also be these set speeds of the first control unit CONTROL 1. It is assumed that the operating data of the existing installation are recorded and also that they are available in a suitable temporal grid of e.g., 4 ms. A series of temporally successive datasets of the existing installation is thus available, each dataset containing the operating data for the respective time. These operating data relating to a time indicate what values the light barrier signals of the conveyor lines FA and FB have measured at this time and what speeds the conveyor belts of the conveyor lines FA and FB had at this time.

The text below explains how the implementation of control of the conveyor line FC can be facilitated using artificial intelligence. This is accomplished by training a machine learning model (subsequently ML model), which then undertakes motion control for the conveyor line FC as part of the control unit CONTROL 2 during the actual operation of the conveyor line. It is possible to train in particular artificial neural networks, recurrent neural networks, convolutional neural networks, perceptrons, Bayesian neural networks, autoencoders, variational autoencoders, Gaussian processes, deep learning architectures, support vector machines, data-driven regression models, k-nearest neighbor classifiers, physical models and/or decision trees. Suitable training methods are in particular methods from the field of reinforcement learning, for example policy gradient processes.

Before the second control unit CONTROL 2 is able to control the conveyor line FC by the ML model, the latter needs to be trained. An assessment of when a gap will arise on the combining unit MERGER is intended to be produced ahead of this training. This can be accomplished by learning a forecast model for the activation of an outgoing light barrier, which is expected over time. This outgoing light barrier is mounted on the combining unit MERGER, but may alternatively also be situated shortly upstream of the combining unit MERGER. It therefore directly indicates when a product of a specified length has arrived on the combining unit MERGER or will reach the combining unit MERGER in a short while. It is not relevant to control, that is to say it only detects the arrival of products on the combining unit MERGER, without the signals from the latter being taken as a basis for control by the first control unit CONTROL 1.

Instead of using the signal from an outgoing light barrier that is actually present, a virtual light barrier can also be used. In this case, a position, e.g., at the end of the combining unit MERGER, is considered and the time at which a product reaches this position is computed. In the case of a virtual light barrier, product positions are tracked up to this position on the conveyor belt. This computation can take place by integrating the speeds of the conveyor belts from the last real light barrier onward. In this way, the activation of a specific point on the combining unit MERGER is thus determined by computation.

The forecast model is not part of the ML model but rather is a model that is independent of the ML model and the forecast results of which are made available to the ML model. The forecast model can also be based on machine learning. Alternatively, the forecast model may be a physical model that takes the speeds of the conveyor belts and the light barrier signals as a basis for computing when the product will arrive at the outgoing light barrier on the basis of physical equations (ideally by taking account of friction at the transitions between the individual conveyor belts).

The operating data, that is to say the light barrier signals and conveyor belt speeds at the present time and for a specified number of preceding time steps, are available for producing the forecast model. The aim of the forecast model is to predict when the outgoing light barrier is triggered for any state. To this end, the times in the historical operating data at which a product begins to pass through the outgoing light barrier, i.e., when the state transition from HIGH to LOW took place for this light barrier, are first considered. If a real light barrier is present, this can be inferred directly from the operating data. Otherwise, these times are determined by computation, as explained.

The top graph in FIG. 3 shows the response of the measured values for the outgoing light barrier. The time here is plotted in time slices on the x axis. A time slice in this instance is the distance between two adjacent datasets containing operating data. At the times at which the signal is at LOW—that is to say has dropped —, there is a product passing through the light barrier. Conversely, there is no product in the light barrier when the signal indicates HIGH. Proceeding from these operating data from the outgoing light barrier that are shown in the top graph, the number of time slices up to the signal change are now determined retrogressively for all preceding states and associated with the respective time slice. This association is shown in the bottom two graphs.

The bottom graph displays the number of time steps t-LOW yet to elapse before the light barrier changes from the HIGH to the LOW state. The maximum number of time steps to elapse is capped at a maximum of 200 steps in this case, corresponding to a forecast horizon of approximately 800 ms if a time slice has the length 4 ms. This explains the partly horizontal response of the value t-LOW.

The middle graph displays the number of time steps t-HIGH yet to elapse before the light barrier changes from the LOW to the HIGH state. With regard to the capping, the same applies as for the response oft-LOW.

For the purpose of learning the forecast model, the light barrier signals of the historical operating data are thus converted into sawtooth functions. A first sawtooth function, shown in the bottom graph, indicates the number of time slices yet to elapse before a falling edge at the outgoing light barrier leads to the LOW state, that is to say a product that has reached the light barrier. A second sawtooth function, shown in the middle graph, indicates the time steps to be expected before the next rising edge, at which the state signal of the light barrier changes to the HIGH status, that is to say a product leaves the light barrier again.

To produce the forecast model, the gotten operating data are enriched with these ascertained sawtooth functions. For a specified time, each dataset therefore by and large contains the respective measured value for each of the light barriers, not only for the outgoing light barrier, and the current speed for each conveyor belt, and additionally the respective value of the sawtooth functions. This allows a forecast to be learned for each state of the existing system regarding how any time steps are expected to elapse before the outgoing light barrier is triggered the next time and after how many time steps the respective product leaves the outgoing light barrier again. The learnt forecast model for product gaps thus takes the conveyor belt speeds and sensor information of all the conveyor belts as a basis for determining when a gap will probably arise at the real or virtual position of the outgoing light barrier on the combining unit MERGER for the subsequent time steps. This is therefore consistent with a prediction of times and lengths of gaps to be expected on the combining unit MERGER.

The second sawtooth function, which is linked to the light barrier being left, is useful in particular when the products have different lengths. If only products of identical length are considered, on the other hand, use of the first sawtooth function is also sufficient.

After the forecast model for product gaps has been produced, these product gaps are intended to be used for the placement of further products. This placement trains the ML model using the forecast model. An optimization process, such as e.g., a reinforcement learning algorithm, can be used to learn a strategy that adjusts the speeds of the conveyor belts on the new finger in such a way that a product from this new finger ends up exactly in the forecast gap on the combining unit MERGER. The input data for the training that are gotten by the ML model are the output from the forecast model, complemented by computed operating data of the new finger, which are obtained from the actions performed by the ML model.

To compute the respective output value, the forecast model receives historical operating data of the existing installation, that is to say the measurement results from the light barriers and the respective current speeds for each time slice. These historical operating data may be the same data as were used to produce the forecast model, or else different historical operating data of the existing installation. The output value from the forecast model is a time that indicates when the next product will reach the outgoing light barrier.

It is advantageous if the output value from the forecast model also contains, in addition to the time at which the outgoing light barrier is reached, the time at which the outgoing light barrier is left. This is useful for products of different length and permits the ML model to maintain specified distances between adjacent products. During training, the ML model therefore receives for each time slice the current output value from the forecast model, based on historical operating data of the existing installation, and the relevant operating data of the new finger, that is to say the respective measurement results for the light barriers and the current speeds, from a simulation.

The training using a reinforcement learning algorithm requires an appropriately chosen cost function, also called a reward function: the learning task involves singularizing products on the combining unit MERGER and maximizing throughput. In this case, the reward function can be defined in such a way that a high reward is achieved if the throughput is high, i.e., a product has transitioned from the last conveyor belt of the new finger to the combining unit MERGER and at the same time a minimum distance from the previous product has been maintained. Similarly, a negative reward is gotten if the distance between two products passing through on the combining unit MERGER is too short or there has been a collision on the combining unit MERGER.

Following completion of the training, the ML model is employed in the second control unit CONTROL 2 to actually control the movement of the conveyor belts. This involves the ML model determining the speeds of the conveyor belts of the added finger in such a way that the aim prescribed in the training is achieved. To this end, the forecast model gets, as input data, the same operating data as were made available for learning the forecast model. That is to say that the current speeds of the conveyor belts and the current measured values for the light barriers of the conveyor lines controlled by the first control unit CONTROL 1 are delivered to the forecast model during actual operation using a temporal clocking that corresponds to the time slices of the historical data. The speeds and measured values are used by the forecast model to determine the output value, which indicates for each time slice when the next product will probably reach the outgoing light barrier, and possibly also when it will leave it again. For each time slice, the ML model gets this output value from the forecast model, and additionally also the relevant operating data of the new finger that it controls.

The described use of an ML model for retrofitting a conveyor line has multiple advantages:

Optimum controls for expanded conveyor installations can be determined without requiring a coordinated new complete system. This allows in particular even installations from competitors to be upgraded. Traditional virtual commissioning methods based on physical models and conventional, non-AI-based controls cannot be employed in this case because the required data are not available for third-party installations. The approach can be employed both for installations from a single manufacturer and for installations from competitors without the control program of the existing installation needing to be known. The installation merely needs to be observable.

Furthermore, producing the forecast model by historical operating data, that is to say purely data-based learning, allows the development complexity for producing a simulation model to be dispensed with. It is therefore not necessary to provide a physical model or physical explanations of the existing installation.

The number of control variables for the retrofit arm, that is to say the speeds to be set for the conveyor belts, is distinctly smaller compared with control of the complete system comprising existing conveyor lines and the new arm. This speeds up training and optimization times because the search space for optimum controls is significantly more reduced.

While the outlined example related to an existing installation having two fingers and one finger to be added, the approach can be applied to any number of fingers. That is to say that in embodiments the method can be used for any number of existing and new supply arms. If in embodiments, the method was programmed, it can be applied without effort to any desired installation containing conveyor belts. The transferability of this method makes it scalable and thus versatile and attractive in terms of price.

In summary, FIG. 4 shows a flowchart relating to the outlined approach. A first step PROG-MODEL comprises learning the forecast model on the basis of the historical operating data DATA FA FB of the existing conveyor lines FA and FB. The ML model then uses the forecast model to train the control of the new conveyor line FC, for which purpose the latter model has a target function prescribed for it that is obtained from the requirements of the actual operation of the installation. The input entered for the training is the output value PROG-OUT from the forecast model, based on historical operating data DATA FA FB of the existing conveyor lines FA and FB, and also computed operating data DATA FC of the conveyor line FC to be controlled by the ML model. Actual operation MOTION CONTROL FC, in which the trained ML model undertakes control of the conveyor line FC by ascertaining and prescribing speeds for the conveyor belts of the conveyor line FC, subsequently takes place. To this end, the ML model gets the output value PROG-OUT from the forecast model, based on the current operating data ACTUAL DATA FA FB of the conveyor lines FA and FB that it does not control, and also the current operating data ACTUAL DATA FC of the conveyor line FC that it controls.

The case in which the forecast model and the ML model are different models has been outlined hitherto. Alternatively, it is also possible for the ML model to comprise the forecast model. In this case, the ML model does not receive the output value from the forecast model, but rather the operating data of the existing conveyor lines directly.

FIG. 5 shows how the control unit CONTROL 2 that implements the ML model and also the forecast model may be designed. Whereas the parts explained more thoroughly below are present a single time in the figure, it is also possible for them to be present as multiples, e.g., as a distributed system. In this way, the functionality of the control unit CONTROL 2 can be split over multiple, possibly hierarchically interlinked, systems. The system or systems may be situated in proximity to the conveyor line or at another location.

The control unit CONTROL 2 comprises a computing unit or a processor PRO. The processor is connected to a memory MEM, which stores a computer program PROGRAM. The computer program PROGRAM can comprise both the forecast model and the ML model; alternatively, separate programs may be available for the forecast model and the ML model. In particular in the latter case, separate memories MEM can also be used. It is also possible for the control unit CONTROL 2 to contain only the ML model, while the forecast model is stored and handled in another unit.

The memory (memories) MEM is (are) a nonvolatile computer-readable data storage medium. Storage can take place in any manner suitable for ensuring readability by a computing unit, such as by magnetic storage, e.g., by floppy disk, optical storage, e.g., by CD, magneto-optical storage, ROM (read-only memory) storage, RAM (random access memory) storage, EPROM (erasable programmable read-only memory), EEPROM (electrically erasable programmable read-only memory), flash memory.

Execution of the instructions of the program PROGRAM in the processor PRO allows the steps of the procedure explained above to be carried out. To this end, the processor PRO is connected to an input and output unit IN/OUT that can be used to exchange information between the control unit CONTROL 2 and other components and/or a user. This interface can be configured in a suitable manner, e.g., by radio or by cable, and the communication can take place using suitable standards.

FIG. 6 shows an illustration to a greater degree of detail of how the control unit CONTROL 2 in FIG. 5 may be configured: this may be a generic computer CONTROL 2 or a mobile generic computer control unit CONTROL 2-MOBILE. In this instance, the generic computer CONTROL 2 represents different types of digital computer devices, such as e.g., desktop computers, workstations, servers, blade servers, mainframes, or other suitable devices. The mobile generic computer CONTROL 2-MOBILE accordingly represents different types of mobile digital computer devices, such as e.g., laptops, PDAs, cell phones or smartphones, or other suitable devices. If FIG. 6 is used to demonstrate and explain components that can be used specifically and in detail, this is intended to be understood as illustrative; the realization of embodiments of the invention are not limited to these components.

The computer CONTROL 2 comprises a processor PRO, a memory MEM and, in between, a high-speed interface HS-INTER. Furthermore, high-speed expansion ports EXP and a low-speed interface LS-INTER are connected to the high-speed interface HS-INTER. The low-speed interface LS-INTER has the storage device STORAGE and the low-speed bus LS-BUS connected to it. The components PRO, MEM, STORAGE, HS-INTER, EXP, LS-INTER are connected by suitable connections/buses and may be installed on a common motherboard.

Whereas the components of the computer CONTROL 2 are shown as singles in FIG. 6, it is also possible to provide for some or all of these components multiple times. The computer CONTROL 2 can also comprise multiple interconnected computers, which may be situated at different locations.

The processor PRO can process instructions that are intended to be executed in the computer CONTROL 2, the instructions being able to be stored in particular in the memory MEM or in the storage device STORAGE. Information, in particular results of the processing in the processor PRO, can be graphically output by a GUI on a display that is connected to the high-speed interface HS-INTER, such as the screen DISPLAY.

The memory MEM is used for storing information within the computer CONTROL 2. This can be a volatile memory or a nonvolatile memory. It can comprise multiple memory cells. The storage device STORAGE is a mass storage device for a computer-readable medium. To this end, it can comprise e.g., a floppy disk drive, a hard disk, a drive for optical storage disks, a tape device, a flash memory storage device, or a series of devices, e.g., in a storage area networks configuration.

The high-speed interface HS-INTER is responsible for bandwidth-intensive processes within the computer CONTROL 2, whereas the low-speed interface LS-INTER is used for processes with less bandwidth requirement. To this end, the high-speed interface HS-INTER is connected to the memory MEM, the screen DISPLAY, possibly via a graphics processor, and the high-speed expansion ports EXP, which can take various expansion cards. Connected to the low-speed interface LS-INTER are the storage device STORAGE and the low-speed bus LS-BUS, on which there can be low-speed expansion ports. The latter can have various communication connections, e.g., USB, Bluetooth, Ethernet or wireless Ethernet. These can have various input and/or output apparatuses connected to them, e.g., a keypad KEYPAD, a mouse MOUSE, a scanner SCAN or a network device NETWORK DEVICE, such as a switch or a router. This distribution of tasks between the two interfaces HS-INTER and LS-INTER is illustrative and may also be organized differently.

The computer CONTROL 2 can be implemented in different ways, as can be seen at the right-hand edge of the figure. For example, it can be implemented as a personal computer PC, as a standard server SERV or a group of such servers, such as e.g., a server farm, or as a rack server system R-SERV or part of such a system.

The mobile computer CONTROL 2-MOBILE comprises a processor PRO, a memory MEM, an input and output apparatus DISPLAY, a communication interface COM-INTER and a transceiver TX/RX. The components PRO, MEM, COM-INTER, TX/RX are connected by suitable connections/buses and may be installed on a common motherboard or in another suitable manner. Furthermore, there may be provision for a further storage device, such as e.g., a microdrive or the like, in order to provide further storage options.

The processor PRO can execute instructions within the mobile computer CONTROL 2-MOBILE, in particular those stored in the memory MEM. It can be implemented as a chip or chipset that contains one or more analog or digital process units. The processor PRO may be responsible inter alia for coordinating the other components of the mobile computer CONTROL 2-MOBILE, such as e.g., for controlling the user interface(s), for applications running on the mobile computer CONTROL 2-MOBILE and for the wireless communication of the mobile computer CONTROL 2-MOBILE. A transmission of information takes place between the user of the mobile computer CONTROL 2-MOBILE and the processor PRO via the user interface USER-INTER, for example by voice input/output, and via the display interface DISPLAY-INTER, for example by text input/output. The input and output apparatus DISPLAY may be based e.g., on TFT LCD (thin-film-transistor liquid crystal display) or OLED (organic light-emitting diode) technology.

Furthermore, there is provision for an external interface EXT-INT connected to the processor PRO, the external interface being able to be used for near field communication between the mobile computer CONTROL 2-MOBILE and other devices. The external interface EXT-INT can be used to communicate by wire and/or by radio.

The memory MEM is used for storing information within the mobile computer CONTROL 2-MOBILE and, to this end, can be implemented e.g., as a volatile or nonvolatile memory comprising one or more storage units. Additionally, there may be provision for an expansion memory EXT-MEM connected to the mobile computer CONTROL 2-MOBILE via the expansion interface MEM-INTER, e.g., an interface for an SIMM (single inline memory module) or a SIM (subscriber identity module). The expansion memory EXT-MEM provides additional storage capacity for the mobile computer CONTROL 2-MOBILE and can also store various applications. For example, the expansion memory EXT-MEM can be used as a security module for the mobile computer CONTROL 2-MOBILE by virtue of identification information being stored therein.

The mobile computer CONTROL 2-MOBILE can communicate wirelessly via the transceiver TX/RX, which, to this end, has means for digital signal processing. The communication interface COM-INTER allows communication using suitable protocols, such as e.g., GSM, SMS, MMS, CDMA, TDMA, PDC, WCDMA, CDMA2000, GPRS, EDGE, UMTS, LTE, and 5th- or higher-generation communication protocols. In addition to the transceiver TX/RX used for this purpose, there may be provision for a transceiver for near field communication, such as e.g., Bluetooth, WiFi or the like, which is not shown. Finally, there may also be provision for a GPS module GPS in order to be able to use location-related services. The audio codec AUDIO can be used to convert received audio information, which can comprise in particular instructions from a user, into digital information that can be processed by the mobile computer CONTROL 2-MOBILE; accordingly, the audio codec AUDIO can be used to generate sound information perceivable to the user.

As can be seen on the right-hand side of the figure, the mobile computer CONTROL 2-MOBILE is implemented as a smartphone PHONE or laptop LAPTOP.

The interaction between the user and the computer CONTROL 2 or the mobile computer CONTROL 2-MOBILE can take place in a wide variety of ways and is not limited to the specific illustration in FIG. 6. Any transmission of information by sensor (visible, audible, touch-perceptible) is possible.

While the components of the computer CONTROL 2 and of the mobile computer CONTROL 2-MOBILE have been described separately, it is also possible to employ one computer that comprises components of both the computer CONTROL 2 and the mobile computer CONTROL 2-MOBILE.

The computer program PROGRAM shown in FIG. 5 can be stored in any of the memories MEM, STORAGE, EXT-MEM in FIG. 6, including in a manner distributed over multiple memories.

Furthermore, storage can alternatively or additionally also be effected in a cloud-based manner.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A process for controlling a conveyor line for general cargo, wherein
the conveyor line comprises a plurality of consecutive conveyor line portions, each of which is driven by a drive, wherein:
the drives are controlled by a computing unit using a machine learning model,
the machine learning model getting first input data on a basis of current operating information from at least one further conveyor line that it does not control,
the machine learning model has previously been trained using second input data on a basis of operating information of the at least one further conveyor line,
the operating information of the at least one further conveyor line relating to measured values from sensors for detecting general cargo and speeds of conveyor line portions.

2. The process as claimed in claim 1, wherein:
the first and second input data comprise at least one temporal forecast value concerning the arrival of an item of general cargo conveyed on the at least one further conveyor line at a specified position, the at least one temporal forecast value is determined from the operating information.

3. The process as claimed in claim 2, wherein:
the at least one temporal forecast value is ascertained by forming at least one sawtooth function that indicates a remaining period of time before an item of general cargo conveyed on the at least one further conveyor line arrives at the specified position.

4. The process as claimed in claim 3, wherein:
the at least one sawtooth function is formed from measured values from a sensor that surveys the specified position in order to detect general cargo.

5. The process as claimed in claim 2, wherein:
the at least one temporal forecast value is ascertained by a forecast model that is independent of the machine learning model,
the forecast model having been produced using operating information of the at least one further conveyor line.

6. The process as claimed in claim 1, wherein:
the conveyor line and the at least one further conveyor line convey items of general cargo to a common section.

7. The process as claimed in claim 6, wherein:
the machine learning model has been trained using a reinforcement learning algorithm with the stipulation that items of general cargo need to be conveyed on the controlled conveyor line in such a way that the items of general cargo reach the common section at a prescribed distance from items of general cargo on the at least one further conveyor line.

8. The process as claimed in claim 2, wherein:
the specified position is located on the common section.

9. The process as claimed in claim 1, wherein:
the machine learning model, for the purpose of control, gets third input data on the basis of current operating information of the conveyor line that it controls, and
the machine learning model has been trained using fourth input data on the basis of operating information of the conveyor line that it controls, which operating information is gotten from a simulation.

10. The process as claimed in claim 1, wherein:
the at least one further conveyor line is controlled using a control algorithm that is unknown to the machine learning model.

11. An apparatus or system for data processing, comprising means for carrying out the process as claimed in claim 1.

12. A computer program product, comprising a computer readable hardware storage device having computer readable program code stored therein, said program code executable by a processor of a computer system to implement a process as claimed in claim 1.

13. A group of computer programs comprising instructions that, when the program is executed by a computer, cause the computer to carry out the steps of the process as claimed in claim 1, comprising
a first computer program for implementing the machine learning model, and
a second computer program for implementing a forecast model to ascertain forecast values concerning the arrival of an item of general cargo conveyed on the at least one further conveyor line at a specified position.

14. A computer-readable storage medium containing a computer program as claimed in claim 12.

15. A data carrier signal that transmits the computer program as claimed in claim 13.
